(19) United States
(12) Patent Application Publication
(10) Pub. No.: US 2025/0013825 A1
(43) Pub. Date: Jan. 9, 2025

(54) INFORMATION PROCESSING DEVICE, INFORMATION PROCESSING METHOD AND INFORMATION PROCESSING PROGRAM

(71) Applicant: NIPPON TELEGRAPH AND TELEPHONE CORPORATION, Tokyo (JP)

(72) Inventors: Atsushi OTSUKA, Musashino-shi, Tokyo (JP); Narichika NOMOTO, Musashino-shi, Tokyo (JP); Atsushi FUKAYAMA, Musashino-shi, Tokyo (JP)

(73) Assignee: NIPPON TELEGRAPH AND TELEPHONE CORPORATION, Tokyo (JP)

(21) Appl. No.: 18/708,215

(22) PCT Filed: Nov. 12, 2021
(86) PCT No.: PCT/JP2021/041807

§ 371 Date: May 8, 2024

(51) Int. Cl. G06F 40/279; G06F 40/40

(52) U.S. Cl. CPC G06F 40/279; G06F 40/40

(57) ABSTRACT

An information processing apparatus includes processing circuitry configured to receive an analysis target sentence as an input and generate a generation sentence, the generation sentence being a sentence regarding content of the analysis target sentence, and a classification type, the classification type being information indicating whether or not the generation sentence is a question sentence for information in which an answer is not included in the analysis target sentence, using a machine learning model learned in advance, and output the generation sentence and the classification type generated.

### TECHNICAL FIELD

The present invention relates to an information processing apparatus, an information processing method, and an information processing program.

### BACKGROUND ART

A question generation technology is a technology for receiving text as an input and generating a question sentence regarding the text in natural language. Many of generated question sentences are used as scenarios and learning data of question-answer systems. However, there are few mechanisms that provide question text itself generated by a question generation technology as a value.

### CITATION LIST

### Patent Literature

[PTL 1] Japanese Laid-open Patent Publication No. 2020-135456

### SUMMARY OF INVENTION

### Technical Problem

However, when an apparatus aiming at presenting generated question text itself is considered, a question sentence generation technology of the related art has a problem that, when a question is generated from original text, a question sentence in which an answer has already been described in the text may be generated.

### Solution to Problem

In order to solve the above problem and achieve the object, the information processing apparatus includes the following units. The question generation unit receives an analysis target sentence as an input and generates a generation sentence, the generation sentence being a sentence regarding content of the analysis target sentence, and a classification type, the classification type being information indicating whether or not the generation sentence is a question sentence for information in which an answer is not included in the analysis target sentence, using a machine learning model learned in advance. The question output unit outputs the generation sentence and the classification type generated by the question generation unit.

### Advantageous Effects of Invention

According to the present invention, a question sentence is not generated when an answer has already been given in text, and a question sentence can be generated when an answer has not been given in text.

### BRIEF DESCRIPTION OF DRAWINGS

FIG. 1 is a block diagram of an information processing apparatus according to an embodiment.

FIG. 2 is a block diagram illustrating details of a question generation unit.

FIG. 3 is a block diagram of a machine learning apparatus that performs learning a question generation model.

FIG. 4 is a diagram illustrating an example of question-answer learning data.

FIG. 5 is an image diagram of learning data for learning the question generation model.

FIG. 6 is a diagram illustrating an example of question sentence creation of the information processing apparatus according to the present embodiment.

FIG. 7 is a flowchart of question generation processing of the information processing apparatus according to an embodiment.

FIG. 8 is a flowchart of machine learning processing of a machine learning apparatus according to the present embodiment.

FIG. 9 is a diagram illustrating experimental results using the information processing apparatus according to the present embodiment.

FIG. 10 is a diagram illustrating an example of a computer that executes an information processing program.

### DESCRIPTION OF EMBODIMENTS

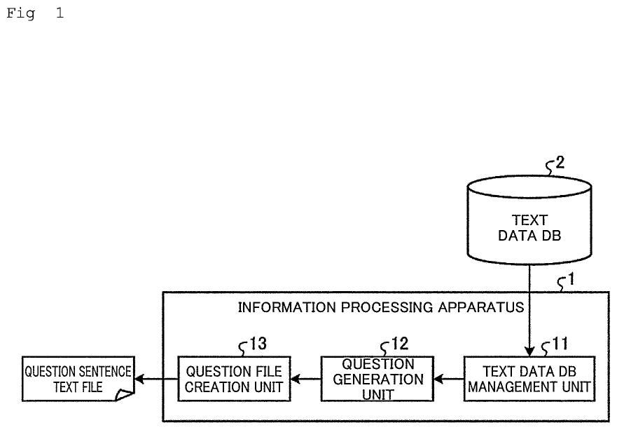

Hereinafter, examples of an information processing apparatus, an information processing method, and an information processing program disclosed in the present application will be described in detail on the basis of the drawings. The information processing apparatus, the information processing method, and the information processing program disclosed in the present application are not limited to the following examples.

[Configuration of Embodiment] FIG. 1 is a block diagram of an information processing apparatus according to an embodiment. A configuration of an information processing apparatus 1 according to the present embodiment will be described with reference to FIG. 1.

The information processing apparatus 1 is connected to a text data DB2. The text data DB2 is a database in which files of various documents are stored. The information processing apparatus 1 includes a text data DB (Data Base) management unit 11, a question generation unit 12, and a question file creation unit 13, as illustrated in FIG. 1.

The text data DB management unit 11 monitors the text data DB2. When the new file entry is added to the text data DB2, the text data DB management unit 11 acquires the text part of the newly added entry. The text data DB management unit 11 transfers the acquired text to the question generation unit 12.

Here, the text data DB management unit 11 can operate with a monitoring frequency of the text data DB2 set to a predetermined cycle. For example, the text data DB management unit 11 may sequentially perform monitoring in units of 5 minutes and transfer a text to the question generation unit 12. Further, the text data DB management unit 11 may collectively process all the entries added on that day as a batch process at night. Alternatively, the text data DB management unit 11 may receive notification that an entry has been added by a signal output from the text data DB2 and acquire the text. Further, the text data DB management unit 11 may transfer text according to predetermined conditions. For example, the text data DB management unit 11 can be set to extract text of a file created by a person who meets predetermined conditions.

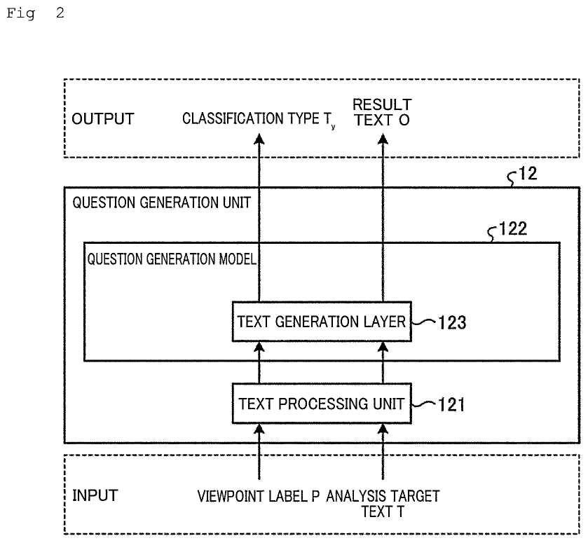

The question generation unit 12 receives the text input from the text data DB management unit 11. The question generation unit 12 generates the question sentence on the basis of the acquired text. Hereinafter, details of question sentence generation of the question generation unit 12 will be described. FIG. 2 is a block diagram illustrating details of the question generation unit. The question generation unit 12 includes a text processing unit 121 and a question generation model 122, as illustrated in FIG. 2. Hereinafter, target text from which the question sentence is generated will be referred to as an “analysis target text”.

The text processing unit 121 receives an input of the analysis target text T acquired from the text data DB management unit 11. The text processing unit 121 also receives an input of the viewpoint label P from an external apparatus (not illustrated). The viewpoint label P may be input in advance using the external apparatus. Both the analysis target text T and the viewpoint label P are character strings.

The viewpoint label P is a label indicating the viewpoint of the question, such as “money” and “legal affair”. The viewpoint label P can be freely set as long as the label is adapted to the content of the text that is the learning data. For example, the viewpoint label P may be an abstract viewpoint such as “money”, or may be a person's name when a collection of questions from the same person is used as learning data.

Here, although a case in which the viewpoint label P is input together with the analysis target text T has been described as an example in the present embodiment, the question generation unit 12 may not use the viewpoint label P in the question generation. In this case, the analysis target text T is input to the text processing unit 121, but the viewpoint label P is not input.

The text processing unit 121 converts a character string representing text into a vector format that can be input to a deep learning model. For example, the text processing unit 121 divides the input analysis target text T into tokens, which are predetermined processing units. Arbitrary words such as morphemes, words, and subwords can be used as predetermined processing units. In the present embodiment, as an example of processing, the text processing unit 121 performs morphological analysis when dividing the text into tokens. The text processing unit 121 assigns an ID (Identifier) corresponding to each token to create a one-hot vector. Accordingly, the text processing unit 121 converts the analysis target text T into a format that can be input to the question generation model 122. Here, any scheme can be adopted for morphological analysis and ID assignment. The text processing unit 121 also converts the viewpoint label P into a vector format.

Thereafter, the text processing unit 121 outputs the analysis target text T and the viewpoint label P converted into the vector format to the question generation model 122.

The question generation model 122 is a deep learning generation model including a text generation layer 123. The question generation model 122 is not particularly limited as a model that can be adopted as long as the model is a neural network model capable of receiving text and outputting text.

The question generation model 122 receives the viewpoint label P and the analysis target text T from the text processing unit 121. The analysis target text T is a text obtained by converting text extracted from the document stored in the text data DB 2 by the text data DB management unit 11 into a vector format using the text processing unit 121.

The question generation model 122, which is a pre-trained neural network model including the text generation layer 123, receives as inputs the viewpoint label P and the analysis target text T converted into a vector format, and performs calculations to generate a classification type Ty and a result text O. Here, when the viewpoint label P is not used, the question generation model 122 receives the analysis target text T converted into the vector format as an input and generates the classification type Ty and the result text O.

The classification type Ty is information for discriminating whether the result text O is a question or extracted text that is a character string extracted from the analysis target text. Moreover, when the viewpoint label P is not used, the classification type Ty is information for discriminating whether the result text O is a question. As the classification type Ty, the question generation model 122 generates a character string “question” when the result text O is the question sentence, and generates a character string “extraction” when the result text O is the extracted text. The character string used here as the information representing the classification type Ty is an example, and other character strings may be set.

As described above, the question generation unit 12 receives the analysis target sentence as an input, and generates a classification type that is information indicating the generation sentence and indicating that the generation sentence a question sentence for information not included in the analysis target sentence using a machine learning model learned in advance. Further, the question generation unit 12 acquires a viewpoint which is information representing a tendency of the description content of the generation sentence, and receives the analysis target sentence and the viewpoint as inputs to generate the generation sentence and the classification type. Here, representing the tendency means indicating to what category the content belongs to, such as “money” and “legal affair,” and may be abstract information such as “money” or may be specific information such as a person name.

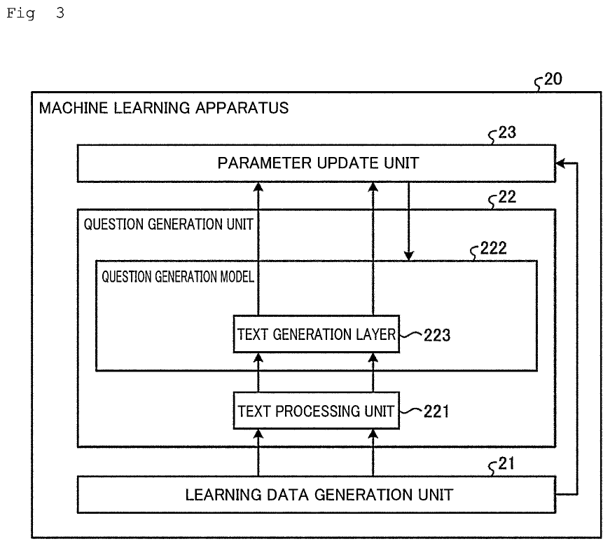

Further, when the question generation unit 12 performs the above-described question generation processing, learning of the question generation model 122 is performed in advance. Hereinafter, learning process of the question generation model 122 will be described. FIG. 3 is a block diagram of a machine learning apparatus that performs learning a question generation model. Here, in the present example, for the sake of clarity, although the learning of the question generation model 122 has been performed using the machine learning apparatus 20 illustrated in FIG. 3, a machine learning function of the machine learning apparatus 20 may be mounted on an information processing apparatus 1. In this case, the information processing apparatus 1 has two operation phases including a learning phase and an inference phase. The information processing apparatus 1 executes a function of the machine learning apparatus 20 in the learning phase, and performs question sentence generation processing in the inference phase.

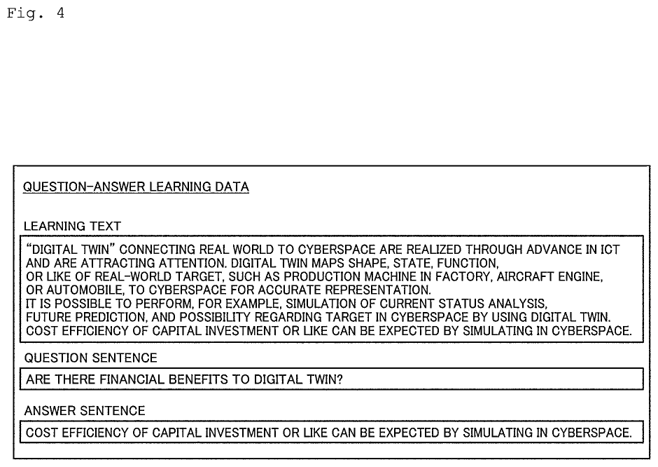

The machine learning apparatus 20 can use text data for question-answer model learning such as machine reading comprehension in order to learn the question generation model 122. FIG. 4 is a diagram illustrating an example of question-answer learning data. The question-answer learning data, which is text data for learning, is formed as a set of three pieces of information including a text for learning, the question sentence, and the answer sentence, as illustrated in FIG. 4. Here, the learning text is a text obtained by extracting a part of the analysis target text. The machine learning apparatus 20 includes a learning data generation unit 21, a question generation unit 22, and a parameter updating unit 23.

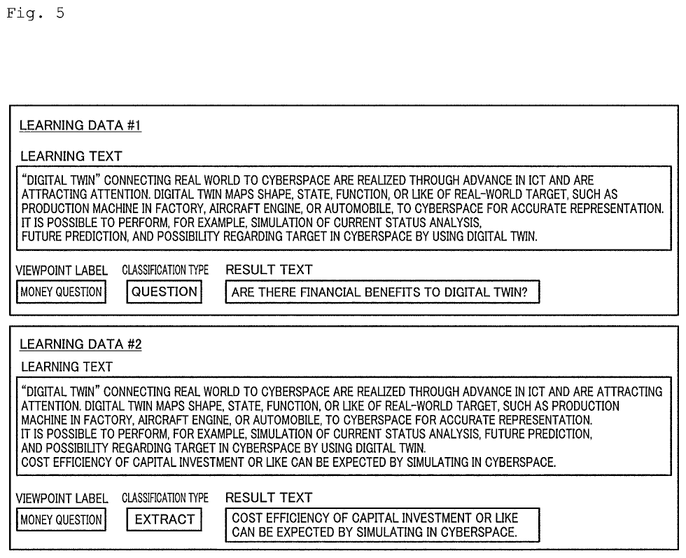

The learning data generation unit 21 acquires the question-answering learning data as illustrated in FIG. 4. FIG. 5 is an image diagram of learning data for learning the question generation model. Here, the learning data generation unit 21 simultaneously creates two types of learning data as illustrated in FIG. 5 from one piece of question-answer learning data as illustrated in FIG. 4.

First learning data #1 on the top of the page of FIG. 5 is learning data for question generation. When the learning data generation unit 21 creates learning data for question generation, the learning data generation unit 21 uses a learning text and question sentence of the question-answer learning data. First, the learning data generation unit 21 deletes the answer sentence part from the learning text in the question-answer learning data to generate a learning text in the learning data for question generation. Next, the learning data generation unit 21 sets the classification type in the learning data for question generation to “question”. Next, the learning data generation unit 21 sets the question sentence of the question answer learning data in the result text of the learning data for question generation. Accordingly, the learning data generation unit 21 sets the learning text as text in which an answer part is missing, and sets the question sentence asking a missing part of the learning text as a correct answer generation sentence.

Second learning data #2 on the lower side of the page of FIG. 4 is learning data for generation of the extracted text. When the learning data generation unit 21 creates learning data for generation of the extracted text, the learning data generation unit 21 uses learning text and answer sentence of the question-answer learning data. In this case, the learning data generation unit 21 sets the learning text of the question-answering learning data as it is as the learning text in the learning data for generation of the extracted text. Next, the learning data generation unit 21 sets the classification type in the learning data for generation of the extracted text to “extraction”. Next, the learning data generation unit 21 sets the answer sentence in the result text of the learning data for generation of the extracted text. Accordingly, the learning data generation unit 21 sets the answer sentence as the correct answer generation sentence.

Thereafter, the learning data generation unit 21 assigns the viewpoint label to the learning data including the learning text, the correct answer classification type, and the correct answer result text to generate learning data. The learning data generation unit 21 outputs the correct answer classification type and the correct answer result text to the parameter updating unit 23. Further, the learning data generation unit 21 outputs the learning text to which the viewpoint label is added to the question generation unit 22.

As described above, when the learning data generation unit 21 acquires the analysis target sentence, the question sentence regarding the content of the analysis target sentence, and the answer sentence that is an answer to the question sentence and includes the information included in the analysis target sentence, removes information serving as an answer to the question sentence from the analysis target sentence and sets the question sentence as a correct answer generation sentence in a case in which a generation sentence with a classification type indicating that the question sentence for information not included in the learning text is generated, and sets the answer sentence as the correct answer generation sentence and generates learning data including the analysis target sentence, the classification type, and the correct answer generation sentence in a case in which a generation sentence with a classification type indicating that the question sentence for information not included in the analysis target sentence is generated. Here, the learning text is an example of the analysis target sentence, and the result text is an example of the generation sentence. The answer sentence that is an answer to the question sentence and includes the information included in the analysis target sentence is an answer sentence to the question sentence and includes information included in the analysis target sentence. Further, the case in which the generation sentence with a classification type indicating that the question sentence is a question sentence for information in which an answer is not included in the analysis target sentence is a generation target is a case in which a generation sentence that is a result text generated by the information processing apparatus 1 has a classification type indicating that the question sentence is the question sentence for information not included in the analysis target sentence, that is, the classification type is “question”. Similarly, the case in which a generation sentence with a classification type indicating that the question sentence is a question sentence for information in which an answer is not included in the analysis target sentence is a generation target is a case in which a generation sentence that is a result text generated by the 1 information processing apparatus has a classification type indicating that the question sentence is not the question sentence for information not included in the analysis target sentence, that is, the classification type is “extraction”.

The question generation unit 22 includes a text processing unit 221 and a question generation model 222. The question generation model 222 is an untrained neural network model that includes a text generation layer 223. The question generation unit 22 performs the same processing as the question generation unit 12 illustrated in FIG. 2. However, the question generation unit 22 performs processing on the basis of the parameters being learned.

The text processing unit 221 performs the same processing as the text processing unit 121 illustrated in FIG. 2. The viewpoint label and learning text output from the text processing unit 221 are input to the question generation model 222.

The question generation model 222 performs the same processing as the question generation model 122 illustrated in FIG. 2 on the input viewpoint label and learning text on the basis of the parameters being learned. The question generation model 222 outputs the generated classification type and result text to the parameter updating unit 23.

The parameter updating unit 23 receives input of the correct answer classification type and the correct answer result text from the learning data generation unit 21. Further, the parameter updating unit 23 receives the input of the classification type and the result text generated by the question generation model 222. The parameter updating unit 23 compares the classification type and the result text generated by the question generation model 222 with the correct answer classification type and the correct answer result text. Thereafter, the parameter updating unit 23 updates the parameters of the question generation model 222 according to a comparison result. Here, the parameter updating unit 23 can use a general learning technology in the machine learning.

Through the above processing, the machine learning apparatus 20 performs learning in which, when an analysis target text that does not include the answer sentence is input, a result text that is the question sentence is generated with the classification type set as “question”. Further, the machine learning apparatus 20 performs learning in which, when an analysis target text including the answer sentence is input, a result text corresponding to the answer sentence is generated with the classification type set to “extraction”. Thereafter, the machine learning apparatus 20 transmits the trained question generation model 222 to the information processing apparatus 1 so that the question generation model 222 is used as the question generation model 122.

Thus, the question generation unit 22 and the parameter updating unit 23 are machine learning execution units that perform learning of the machine learning model on the basis of the learning data generated by the learning data generation unit 21.

Here, the question generation unit 12 and the question generation unit 22 may use a binary classification model instead of a character string for the classification type. The binary classification model in this case represents a binary value indicating whether or not extraction is performed, and for example, a method of assigning 1 to the extraction and assigning 0 to the classification can be used. Further, the question generation unit 12 and the question generation unit 22 may adopt a learning method of connecting the classification type and the result text to generate one character string.

Further, a suitable existing technology can be adopted as a method of assigning a viewpoint label to learning data. For example, the viewpoint label may be set manually, or a method in which the question generation unit 12 or the question generation unit 22 automatically sets the viewpoint label using keyword matching or a classification model may be adopted.

Referring back to FIG. 1, the description continues. The question file creation unit 13 creates a file in which the questions generated by the question generation unit 12 are described. The question file creation unit 13 outputs the created file. For example, the question file creation unit 13 performs processing such as uploading the created file to a shared folder for uploading a document. Here, a format and description content of the file generated by the question file creation unit 13 can be freely set. For example, the question file creation unit 13 may describe both the question text and the viewpoint in the file describing the question, or may describe only the question text. Further, the output of the file created by the question file creation unit 13 is not limited to uploading to a folder. In addition, the question file creation unit 13 may transmit the created file to an uploader of the document by e-mail, or may output the content of the file to a chatbot or the like to notify of the content in a chat format.

This question file creation unit 13 corresponds to an example of a “question output unit”. That is, the question file creation unit 13 outputs the generation sentence and the classification type generated by the question generation unit 12.

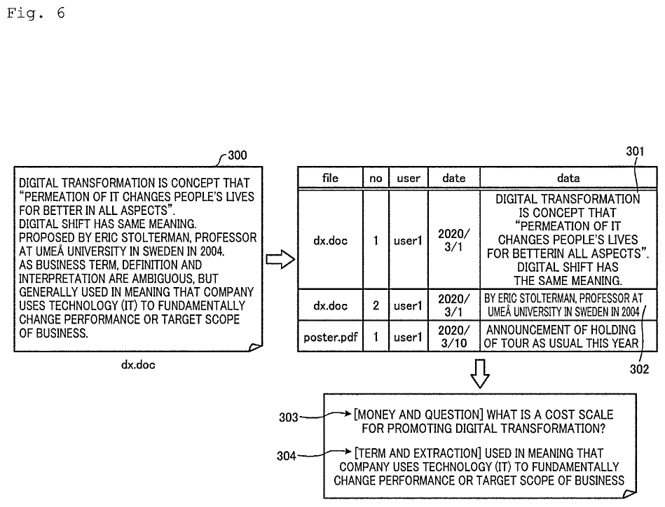

FIG. 6 is a diagram illustrating an example of question sentence creation of the information processing apparatus according to the present embodiment. Here, a case in which a file 200 illustrated in FIG. 6 is prepared will be described. Here, sentences included in the prepared file 200 are stored as entries 201 and 202 in the text data DB2 in units of sentences. However, a storage method is not limited thereto, and for example, all sentences in the file 200 may be stored in one entry.

The text data DB management unit 11 of the information processing apparatus 1 monitors the text data DB 2 and acquires the analysis target text from the entry 201 of the new file. For example, the text data DB management unit 11 acquires a character string “digital transformation is a concept that “the permeation of IT changes people's lives for the better in all aspects”. Digital shift has the same meaning” as the analysis target text. The text data DB management unit 11 transfers the acquired analysis target text to the question generation unit 12.

When “money” is input as the viewpoint label, the question generation unit 12 outputs the question as the classification type, and generates and outputs the question sentence 203 as a result text from the analysis target text. Further, when “term” is input as the viewpoint label, the question generation unit 12 outputs extraction as the classification type, and generates and outputs the extracted text 204 as the result text from the analysis target text.

The question file creation unit 13 adds a label of [money/question] to the question sentence 203 created by the question generation unit 12 to create a file. As a result, the question file creation unit 13 indicates that the viewpoint label is money in the question sentence 203 and that the question is generated. Further, the question file creation unit 13 assigns a label of [term/extraction] to the extracted text 204 created by the question generation unit 12 to create a file. Accordingly, the question file creation unit 13 indicates that the description in the analysis target text is used as it is since a viewpoint regarding definitions of terms are used and the corresponding part exists in the analysis target text in the extracted text 204.

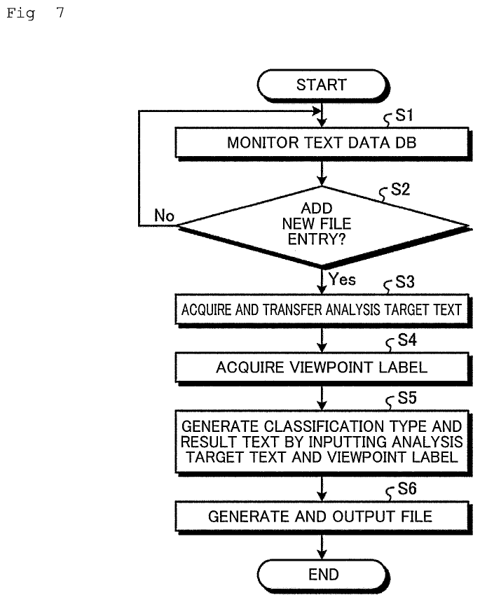

As described above, the question file creation unit 13 outputs the result text and the classification type, which are the generation sentences generated by the question generation unit 12. Further, the question file creation unit 13 adds the viewpoint information to output the result text and the classification type.

[Processing of Embodiment] FIG. 7 is a flowchart of question generation processing of the information processing apparatus according to an embodiment. Next, a flow of question generation processing of the information processing apparatus 1 according to the present embodiment will be described with reference to FIG. 7.

The text data DB management unit 11 monitors the text data DB2 (step S1).

The text data DB management unit 11 determines whether or not a new file entry has been added to the text data DB2 (step S2). When no new file entry has been added (step S2: NO), the text data DB management unit 11 returns to step S1 and waits until the new file entry is added.

On the other hand, when the new file entry is added (step S2: Yes), the text data DB management unit 11 acquires the text part of the newly added entry as the analysis target text. The text data DB management unit 11 transfers the acquired analysis target text to the question generation unit 12 (step S3).

The question generation unit 12 acquires the analysis target text from the text data DB management unit 11. Further, the question generation unit 12 acquires a viewpoint label from an external apparatus or the like (step S4).

The text processing unit 121 of the question generation unit 12 converts the analysis target text and the viewpoint label into a vector format. The text processing unit 121 inputs the analysis target text and the viewpoint label converted into the vectors to the question generation model 122. The question generation model 122 receives the analysis target text and the viewpoint label converted into the vectors, and generates the classification type and the result text using the text generation layer 123 (step S5).

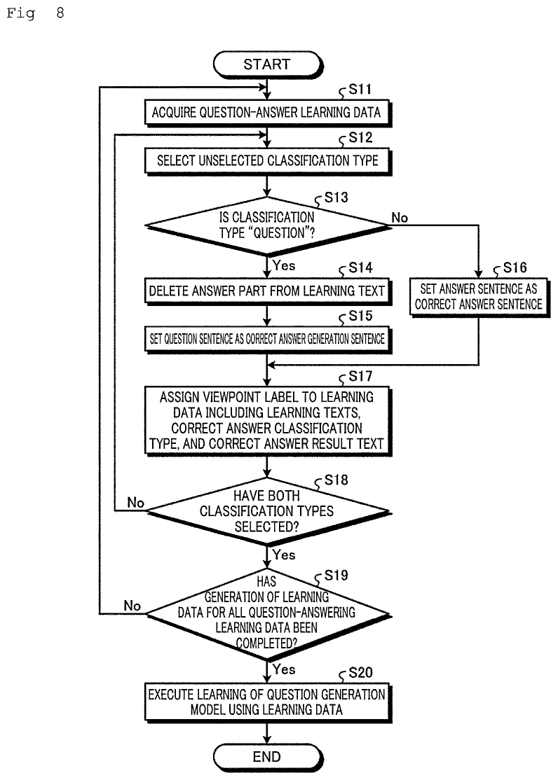

The question file creation unit 13 receives the input of the classification type and the result text from the question generation unit 12. The question file creation unit 13 assigns a viewpoint label and a classification type to create a file in which the result text is registered. Thereafter, the question file creation unit 13 outputs the created file (step S6).

[Processing of Embodiment] FIG. 8 is a flowchart of machine learning processing of the machine learning apparatus according to the present embodiment. Next, a flow of machine learning processing of the machine learning apparatus 20 according to the present embodiment will be described with reference to FIG. 8.

The learning data generation unit 21 acquires question-answer learning data including a learning text, the question sentence, and the answer sentence (step S11).

Next, the learning data generation unit 21 selects one unselected classification type from among the classification types of “question” and “extraction” (step S12).

Next, the learning data generation unit 21 determines whether or not the selected classification type is “question” (step S13).

When the selected classification type is “question” (step S13: Yes), the learning data generation unit 21 deletes the answer part from the learning text (step S14).

Next, the learning data generation unit 21 sets the question sentence as the correct answer generation sentence (step S15). Thereafter, the learning data generation unit 21 proceeds to step S17.

On the other hand, when the selected classification type is “extraction” and not “question” (step S13: No), the learning data generation unit 21 sets the answer sentence as the correct answer generation sentence (step S16). Thereafter, the learning data generation unit 21 proceeds to step S17.

Next, the learning data generation unit 21 assigns viewpoint labels to the learning data including the learning text, the correct answer classification type, and the correct answer result text to generates learning data (step S17).

Next, the learning data generation unit 21 determines whether or not both classification types have been selected for current the question-answering learning data (step S18). When unselected classification types remain (step S18: No), the learning data generation unit 21 returns to step S12.

On the other hand, when both classification types have been selected (step S18: Yes), the learning data generation unit 21 determines whether or not the generation of the learning data for all the pieces of question-answering learning data has been completed (step S19). When the question-answer learning data for which the learning data has not been generated remains (step S19: No), the learning data generation unit 21 returns to step S11.

On the other hand, when the generation of the learning data for all the pieces of question-answering learning data is completed (step S19: Yes), the learning data generation unit 21 outputs the generated learning data to the question generation unit 22. The question generation unit 22 and the parameter updating unit 23 use the learning data to execute learning of the question generation model 222 (step S20).

[Experimental Results] Next, an experiment of question generation of the information processing apparatus 1 according to the present embodiment will be described. Here, an evaluation corpus was created using a manual and viewpoint classifier, and model learning and evaluation were performed. More specifically, an evaluation corpus was generated according to the following procedure. First, the analysis target text, which is a sentence from which the question is generated, is acquired from a particular website. Next, the question sentence is manually created for the acquired analysis target text. Next, when an answer to the created question sentence exists in the analysis target text, a label of “extraction”, which is the classification type when there is an answer, is assigned. Further, when the answer to the created question sentence does not exist in the analysis target text, the label of “question”, which is the classification type when there is no answer, is manually assigned. Next, when there is an answer, a part as the answer is manually extracted as the “result text” from the analysis target text. Next, a viewpoint is assigned to the created question sentence. Here, five viewpoints for four classifications mechanically created by keyword-based classifications for experiments and other classifications were used as viewpoints for experimental questions. Four viewpoints are money, law, performance, and reason. The money is a category that includes keywords such as how much, fee, cost, and reward. The law is a classification that includes keywords such as illegal, rule, contract, and audit. The performance is a perspective that includes keywords such as evaluation, experimentation, ability, comparison, and performance. The reason is a perspective that includes keywords such as why, cause, why, and causality. However, this viewpoint assignment may be performed manually. Accordingly, all or some of pairs of texts and questions manually created by the above procedure were used for the evaluation corpus.

Further, as the question generation model 122, the following two types of language generation models were used. One is Hobbyiest that is a dialogue model developed by NTT Communication Science Laboratories (https://github. com/nttcslab/japanese-dialog-transformers/blob/main/README-jp.md). The other one is the Japanese T5 that is a model on the Huggingface model hub (https://huggingface.co/sonoisa/t5-base-japanese). Further, the following model learning corpus was used for learning the question generation model 122.195053 machine reading comprehension corpora were used as the question-answer learning data. Further, 9755 questions prepared by the same people as the evaluation questions were used. Of these, the total number of actually used model learning corpora is 204394.

The following evaluation experiment was performed on the trained question generation model 122 using the evaluation corpus. First, data with “there is no answer”, that is, data with the classification type of “question” is selected from the evaluation corpora. This data includes a manually generated question, the analysis target text, and the viewpoint label. The viewpoint label and the analysis target text are input to the question generation model 122.

Thereafter, it was verified whether a question was generated as an output of the question generation model 122 or whether the generated question was close to a manually generated question.

Next, data with “there is an answer”, that is, data of which the classification type is “extraction” is selected from the evaluation corpus. This data includes the manually generated question, the analysis target text, the viewpoint label and the answer sentence. The viewpoint label and the analysis target text are input to the question generation model 122. Thereafter, it was verified whether the same answer sentence as the evaluation corpus could be extracted as the output of the question generation model 122.

As an evaluation criterion, a question correct answer rate, a question average BERT score, a question average ranking, and a viewpoint correct answer rate were used. Here, evaluation was performed using five highly evaluated output results. The question correct answer rate, the average question BERT score, and the average question ranking are evaluation criteria when using data of “there is no answer” in the evaluation corpus. Further, the viewpoint correct answer rate is an evaluation criterion when using the data of “there is an answer” in the evaluation corpus.

The question correct answer rate is a rate of a question that is a correct answer in the result text. In other words, the question correct answer rate is a rate of a manually generated question in the evaluation corpus in the result text output by the question generation model 122.

Further, the question average BERT score is a semantic similarity between the manually generated question and the result text. In other words, the question BERT score is a text similarity. For example, a BERT score of the question sentence such as “How much resources are estimated to realize DTC?” is considered. In this case, the BERT score of the question such as “How much should I invest to realize DTC?” is 0.775. Further, the BERT score of the question such as “Is there any legal problem with DTC?” is 0.721. Further, the BERT score of the question such as “Is NTT promoting IWON?” is 0.693.

The question average reverse rank is a reciprocal of the rank of the first correct answer question among the five output results with high evaluation. For example, when the first correct answer question comes out, the question average reverse rank is 1. Further, when the second correct answer question comes out, the question average reverse rank is 1. Further, when the third correct answer question comes up, the question average reverse rank is 0.33 (=1/3). That is, the question average reverse rank is an evaluation criterion in which, when the correct answer is higher, the score is closer to 1, and in this case, the evaluation becomes higher.

The viewpoint correct answer rate is a rate at which result text of the same viewpoint as the correct answer is output. As described above, the viewpoint correct answer rate is used for evaluation when the data “there is an answer” in the evaluation corpus is used.

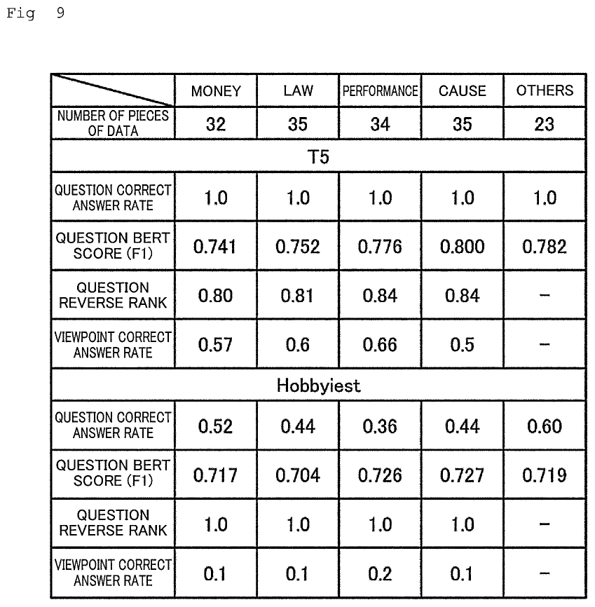

FIG. 9 is a diagram illustrating experimental results using the information processing apparatus according to the present embodiment. In FIG. 9, for each of five viewpoint labels, the values of the question correct answer rate, question BERT score, question reverse rank, and viewpoint correct answer rate when Japanese T5 is used as the question generation model 122 and Hobbyiest is used are shown. In this case, Japanese T5 is superior regardless of whether the result text is the question sentence or the extracted text. Hobbyiest often outputs only question or only viewpoint at the time of N-best. An influence of the pre-learning model is highly likely to be large. In Japanese T5, a question with content relatively similar to the manually created question was generated.

[Effects of Embodiment] As described above, the information processing apparatus 1 according to the present embodiment acquires the analysis target text registered in the text data DB2, and generates the question sentence together with the classification type. This makes it possible to determine whether or not the analysis target text includes an answer to the created question sentence. The use of this determination result makes it possible to extract the text that does not include the answer, not to generate the question sentence when the answer has already been described in the text, and to generate the question sentence when the answer is not described in the text.

Further, in the information processing apparatus 1 according to the present embodiment, a “viewpoint label” was introduced in order to more reliably solve a problem of generating the question sentence from a certain text when generating a question from a text. The information processing apparatus 1 acquires the analysis target text registered in the text data DB2 and generates the question sentence according to the viewpoint of the designated viewpoint label. Further, the information processing apparatus 1 extracts and outputs a description according to the viewpoint of the designated viewpoint label from the analysis target text. Accordingly, the information processing apparatus 1 according to the present embodiment generates a question regarding an input viewpoint when the description regarding the input viewpoint does not exist in the text, and generates the text by extracting a corresponding part in the text when the description regarding the input viewpoint has already existed in the text. That is, it is possible to more reliably generate a question sentence in which the answer is not described in the text. Further, it is possible to know that necessary information exists in the text from that viewpoint and how the information is described when a sentence of which the classification type is “extraction” is generated by performing sentence generation based on the viewpoint. Therefore, it is possible to help the user understand why the question is not generated. Further, it is possible to create a collection of assumed questions for a specific person by using the specific person as a viewpoint.

The information processing apparatus 1 and the machine learning apparatus 20 according to the present embodiment provide specific improvement to a question generation technology of the related art for generating even a question sentence in which an answer has already been written in text when generating a question from a text, and shows an improvement in the technical field related to a question generation technology when it is not known whether the answer is described in the text.

[System Configuration, or the Like] Further, each component of each illustrated apparatus is functionally conceptual, and does not necessarily need to be physically configured as illustrated. In other words, a specific form of distribution and integration of each apparatus is not limited to the illustrated one, and all or some of these can be functionally or physically distributed or integrated and configured in any units depending on various loads, use situations, or the like. Further, all or some of respective processing functions performed by each apparatus may be realized by a central processing unit (CPU) and a program analyzed and executed by the CPU, or may be realized as hardware by wired logic. Further, each processing function performed by each apparatus may be realized using a graphics processing unit (GPU).

Further, among the processing described in the embodiment, all or some of the processing described as being automatically performed can be performed manually, or all or some of processing described as being performed manually can be performed automatically by using a known method. Further, information including a processing procedure, control procedure, specific names, and various types of data or parameters illustrated in the above documents or drawings can be arbitrarily changed unless otherwise specified.

[Program] As an embodiment, the information processing apparatus 1 and the machine learning apparatus 20 can be implemented by installing an information processing program for executing the question generation processing as package software or online software on a desired computer. For example, the computer can function as the information processing apparatus 1 or the machine learning apparatus 20 by causing the computer to execute the information processing program. The computer referred to here includes a desktop or laptop personal computer. In addition, the computer includes a mobile communication terminal such as a smartphone, a mobile phone or a personal handy-phone system (PHS), and a slate terminal such as a personal digital assistant (PDA). The information processing apparatus 1 may be implemented as a Web server, or may be implemented as a cloud that provides service regarding the management processing by outsourcing.

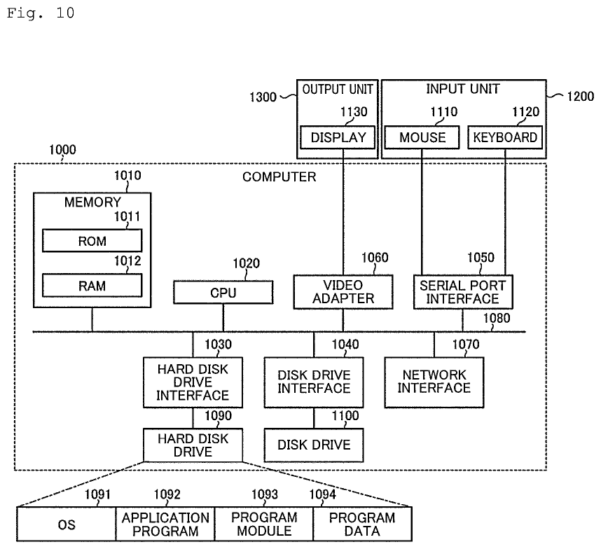

FIG. 10 is a diagram illustrating an example of a computer that executes an information processing program. A computer 1000 includes a memory 1010 and a CPU 1020, for example. Further, the computer 1000 includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program, such as a basic input output system (BIOS). The hard disk drive interface 1030 is connected to a hard disk drive 1090. The disk drive interface 1040 is connected to a disc drive 1100. A detachable storage medium such as a magnetic disk or optical disc, for example, is inserted into the disc drive 1100. The serial port interface 1050 is connected to an input unit 1200 such as a mouse 1110 or a keyboard 1120, for example. The video adapter 1060 is connected to the output 1300, such as a display 1130.

The hard disk drive 1090 stores an OS 1091, an application program 1092, a program module 1093, and program data 1094, for example. That is, a program defining each processing of the information processing apparatus 1 or the machine learning apparatus 20 having the same functions as the information processing apparatus 1 or the machine learning apparatus 20 is implemented as the program module 1093 in which computer-executable code is described. The program module 1093 is stored in, for example, the hard disk drive 1090. For example, the program module 1093 for executing the same processing as the functional configuration in the information processing apparatus 1 or the machine learning apparatus 20 is stored in the hard disk drive 1090. The hard disk drive 1090 may be replaced with a solid state drive (SSD).

Further, configuration data to be used in the processing of the embodiment described above is stored as the program data 1094 in, for example, the memory 1010 or the hard disk drive 1090. The CPU 1020 reads the program module 1093 or the program data 1094 stored in the memory 1010 or the hard disk drive 1090 into the RAM 1012 as necessary, and executes the processing of the above-described embodiment.

The program module 1093 or the program data 1094 is not limited to being stored in the hard disk drive 1090, and may be stored, for example, in a detachable storage medium and read by the CPU 1020 via the disc drive 1100 or the like. Alternatively, the program module 1093 and the program data 1094 may be stored in another computer connected via a network (a local area network (LAN), a wide area network (WAN), or the like). The program module 1093 and the program data 1094 may be read from another computer via the network interface 1070 by the CPU 1020.

### Appendix 1

An information processing apparatus includes a memory; and
at least one processor connected to the memory,
wherein the processor
receives an analysis target sentence as an input and generates a generation sentence, the generation sentence being a sentence regarding content of the analysis target sentence, and a classification type, the classification type being information indicating whether or not the generation sentence is a question sentence for information in which an answer is not included in the analysis target sentence, using a machine learning model learned in advance, and
outputs the generated generation sentence and the classification type.

### Appendix 2

A non-transitory storage medium storing a computer-executable program to execute information processing,
the information processing including:
receiving an analysis target sentence as an input and generating a generation sentence, the generation sentence being a sentence regarding content of the analysis target sentence, and a classification type, the classification type being information indicating whether or not the generation sentence is a question sentence for information in which an answer is not included in the analysis target sentence, using a machine learning model learned in advance; and
outputting the generated generation sentence and the classification type.

### Appendix 3

An information processing apparatus includes a memory; and
at least one processor connected to the memory,
wherein the processor
acquires an analysis target sentence, a question sentence regarding content of the analysis target sentence, and an answer sentence including information included in the analysis target sentence, the answer sentence being an answer to the question sentence, removes information serving as an answer to the question sentence from the analysis target sentence and sets the question sentence as a correct answer generation sentence in a case in which the generation sentence with a classification type indicating that the question sentence is a question sentence for information in which an answer is not included in the analysis target sentence is a generation target, and sets the answer sentence as the correct answer generation sentence and generates learning data including the analysis target sentence, the classification type, and the correct answer generation sentence when the generation sentence with the classification type indicating that the question sentence is not a question sentence for information in which an answer is not included in the analysis target sentence is a generation target; and
performs learning of a machine learning model on the basis of the generated learning data.

(Here, the answer sentence that is an answer to the question sentence and includes the information included in the analysis target sentence is an answer sentence to the question sentence and includes information included in the analysis target sentence. Further, the case in which the generation sentence with a classification type indicating that the question sentence is a question sentence for information not included in the analysis target sentence is a generation target is a case in which a generation sentence generated by the information processing apparatus has a classification type indicating that the question sentence is the question sentence for information not included in the analysis target sentence. Similarly, the case in which a generation sentence with a classification type indicating that the question sentence is a question sentence for information in which an answer is not included in the analysis target sentence is a generation target is a case in which a generation sentence that is a result text generated by an information processing apparatus has a classification type indicating that the question sentence is not the question sentence for information not included in the analysis target sentence.

### Appendix 4

A non-transitory storage medium storing a computer-executable program to execute information processing,
the information processing including:
acquiring an analysis target sentence, a question sentence regarding content of the analysis target sentence, and an answer sentence including information included in the analysis target sentence, the answer sentence being an answer to the question sentence, removing information serving as an answer to the question sentence from the analysis target sentence and setting the question sentence as a correct answer generation sentence in a case in which the generation sentence with a classification type indicating that the question sentence is a question sentence for information in which an answer is not included in the analysis target sentence is a generation target, and setting the answer sentence as the correct answer generation sentence and generating learning data including the analysis target sentence, the classification type, and the correct answer generation sentence when the generation sentence with the classification type indicating that the question sentence is not a question sentence for information in which an answer is not included in the analysis target sentence is a generation target; and performing learning of a machine learning model on the basis of the generated learning data.

All literatures, patent applications, and technical standards described herein are incorporated herein by reference to the same extent as when each individual publication, patent application and technical standard are specifically and individually described as being incorporated by reference.

### REFERENCE SIGNS LIST

1 Information processing apparatus
2 Text data DB
11 Text data DB management unit
12 Question generation unit
13 Question file creation unit
20 Machine learning apparatus
21 Learning data generation unit
22 Question generation unit
23 Parameter updating unit
121 Text processing unit
122 Question generation model
123 Text generation layer
221 Text processing unit
222 Question generation model
223 Text generation layer

1. An information processing apparatus comprising:
processing circuitry configured to:
receive an analysis target sentence as an input and generate a generation sentence, the generation sentence being a sentence regarding content of the analysis target sentence, and a classification type, the classification type being information indicating whether or not the generation sentence is a question sentence for information in which an answer is not included in the analysis target sentence, using a machine learning model learned in advance; and
output the generation sentence and the classification type generated.

2. The information processing apparatus according to claim 1, wherein the processing circuitry is further configured to acquire a viewpoint which is information representing a tendency of description content of the generation sentence, and receive the analysis target sentence and the viewpoint as inputs to generate the generation sentence and the classification type.

3. The information processing apparatus according to claim 2, wherein the processing circuitry is further configured to add information of the viewpoint and output the generation sentence and the classification type.

4. An information processing method comprising:
receiving an analysis target sentence as an input and generating a generation sentence, the generation sentence being a sentence regarding content of the analysis target sentence, and a classification type, the classification type being information indicating whether or not the generation sentence is a question sentence for information in which an answer is not included in the analysis target sentence, using a machine learning model learned in advance, by processing circuitry; and
outputting the generated generation sentence and the classification type.

5. A non-transitory computer-readable recording medium storing therein an information processing program that causes a computer to execute a process comprising:
receiving an analysis target sentence as an input and generating a generation sentence, the generation sentence being a sentence regarding content of the analysis target sentence, and a classification type, the classification type being information indicating whether or not the generation sentence is a question sentence for information in which an answer is not included in the analysis target sentence, using a machine learning model learned in advance; and
outputting the generated generation sentence and the classification type.

6.-8. (canceled)
